(19) United States
(12) Patent Application Publication
(10) Pub. No.: US 2013/0198552 A1
(43) Pub. Date: Aug. 1, 2013

(54) POWER CONSUMPTION MONITORING

(71) Applicants: Simon Ponsford, Doha (QA); Simon Guerrero, Doha (QA); Maged Zereba, Doha (QA)

(72) Inventors: Simon Ponsford, Doha (QA); Simon Guerrero, Doha (QA); Maged Zereba, Doha (QA)

(73) Assignee: Qatar Foundation, Doha (QA)

(21) Appl. No.: 13/370,063

(22) Filed: Feb. 9, 2012

(30) Foreign Application Priority Data
Jan. 31, 2012 (GB) 1201590.5

(51) Int. Cl. G06F 1/26

(52) U.S. Cl. 713/340

(57) ABSTRACT

A method implemented on a computing device for computing power consumption of an activity executing on the device, comprises periodically polling a management controller of the device for a power consumption measurement from a sensor communicatively coupled to the controller, and storing a power consumption value in a memory of the device to make it available for use by an application.

### CROSS REFERENCE TO RELATED APPLICATIONS

This application claims foreign priority from UK Patent Application Serial No. 1201590.5, filed 31 Jan. 2012.

### BACKGROUND

With environmental impacts such as rapidly decreasing fossil fuels and global warming, as well as increasing cost, individuals and organisations are becoming more aware of their power consumption. It is also likely that legislation will begin to mean that organisations will need to report their power use in terms of efficiency and use of resources.

Typically, a large proportion of power consumed by many organisations is as a result of their IT infrastructure and the use of the devices associated therewith. While it is possible to determine an organisation's power consumption at a site level for example, in order to produce a more accurate picture it is necessary to measure consumption at a lower level of granularity, such as, for example, at an individual device level, whether that be a physical device, or, more commonly, a virtual device.

### SUMMARY

According to example there is provided a system and method to determine and provide to an application an up to date power consumption figure for a device, component or virtual machine. An intelligent platform management interface can be queried periodically so that current power consumption values can be stored in memory for use by other applications. In an example, a baseline value can be established to indicate a power consumption when a device is idle—that is, with no applications or virtual machines running for example.

According to an example, there is provided a method implemented on a computing device for computing power consumption of an activity executing on the device, comprising periodically polling a management controller of the device for a power consumption from a sensor communicatively coupled to the controller, and storing the measurement in a memory of the device to make it available for use by an application. Polling a management controller includes making an out-of-band request for power consumption data from the controller. The management controller may be polled once every second. In other examples, the controller may be polled at a frequency of less than 1 Hz. The stored measurement is used to provide a reference value for the power consumption. The reference value represents an operating state of the device when under no application or virtual machine load.

According to an example, there is provided a method implemented on a computing device for monitoring power consumption of a virtual machine residing on a physical host server, the method comprising periodically polling a management controller of the host server for a power consumption measurement from a sensor communicatively coupled to the controller and representing a current server power consumption value, using the measurement to estimate the power consumption of the virtual machine with reference to a reference value for power consumption of the server and a number of hosted virtual machines on the server, thereby producing power consumption values, and storing the power consumption values in a memory of the server to make it available for use by an application. Estimating the power consumption of the virtual machine includes determining the relative CPU usage of the virtual machine as a proportion of the overall CPU resource of all virtual machines including a host OS residing on the server. The management controller is polled at least once every second. In other examples, the controller is polled at a frequency of less than 1 Hz. The stored measurement is used to provide the reference value for the power consumption. The reference value represents an operating state of the server when under no application or virtual machine load.

According to an example, there is provided a system for determining power consumption of an activity executing on a device, comprising a management controller of the device to determine a power consumption measurement from a sensor communicatively coupled to the controller, an agent module to periodically poll the management controller for the power consumption measurement, and a memory to store the derived value to make it available for use by an application. The agent can poll the management controller at least once every second, or less frequently. The management controller can provide a reference value representing an operating state of the device when under no application or virtual machine load. The device can be a host server to execute a virtual machine manager to support a virtual machine. The system can further comprise a processor or processors to estimate the power consumption of the virtual machine with reference to a reference value for power consumption of the server and a number of hosted virtual machines on the server. The processor or processors can estimate the power consumption of the virtual machine by computing the relative CPU usage of the virtual machine as a proportion of the overall CPU resource of all virtual machines including a host OS residing on the server.

### BRIEF DESCRIPTION OF THE DRAWINGS

An embodiment of the invention will now be described, by way of example only, and with reference to the accompanying drawings, in which:

FIG. 1 is a schematic block diagram of management controller for a device according to an example;

FIG. 2 is a schematic block diagram of a system according to an example;

FIG. 3 is a schematic block diagram of a virtual machine according to an example;

FIG. 4 is a flowchart for a method according to an example; and

FIG. 5 is a flowchart for a method according to an example.

### DETAILED DESCRIPTION

It will be understood that, although the terms first, second, etc. may be used herein to describe various elements, these elements should not be limited by these terms. These terms are only used to distinguish one element from another. For example, a first gesture could be termed a second gesture, and, similarly, a second gesture could be termed a first gesture.

The terminology used herein is for the purpose of describing particular examples only and is not intended to be limiting. As used herein, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used in the present specification and in the appended claims, the term “hypervisor” refers to a program that is executed directly by the underlying hardware of a computing device to implement one or more separate virtual machines and one or more virtualized appliances using the underlying hardware. For the purposes of the present specification and claims, the term “hypervisor” shall be viewed as synonymous to that of a “Virtual Machine Monitor” (VMM). As used in the present specification and in the appended claims, the term “virtual machine” refers to a software implementation of a computing device that is configured to autonomously execute programs like a physical computing device.

The vast majority of computer systems in use today have sensors built into their hardware to measure power consumption, as well as fan speeds, chip temperatures and so forth. This information is typically made available to the operating system via low-level calls. The modern standard for supplying such platform information is IPMI (Intelligent Platform Management Interface), which is supported by multiple platform vendors. It provides a mechanism by which application code can query the hardware to obtain the appropriate sensor values, as well as providing direct control over aspects of the server's behaviour such as cycling the power.

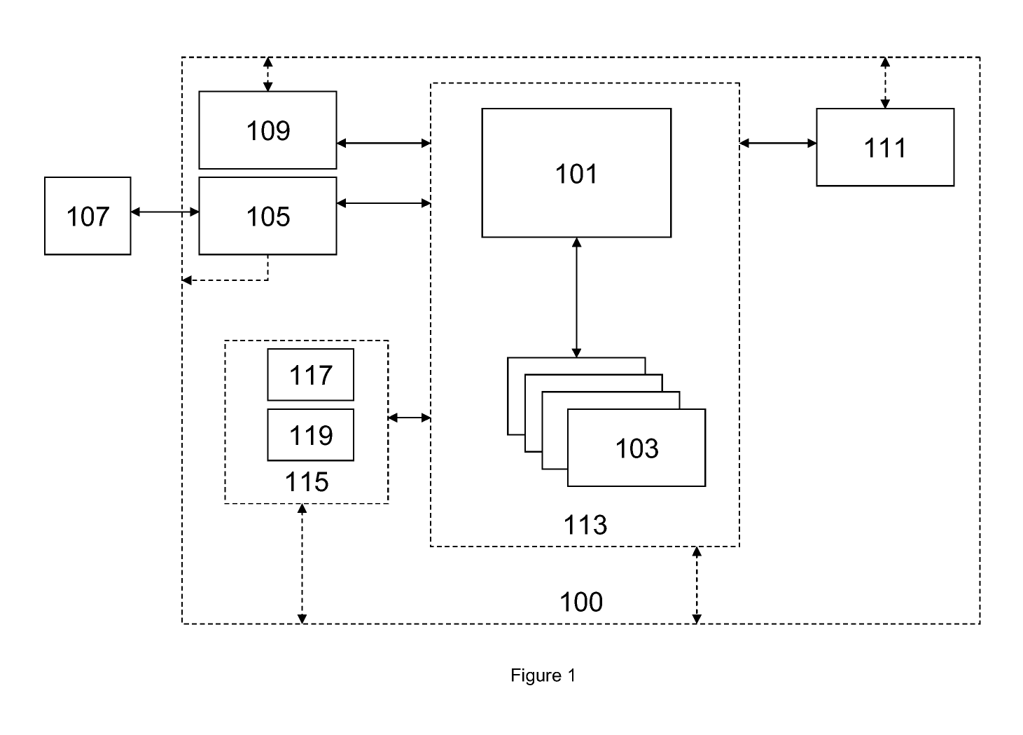

FIG. 1 is a schematic block diagram of management controller for a device according to an example.

A management controller 101 which can be microcontroller for example is embedded or otherwise communicatively coupled to a motherboard of a computing device 100 such as a server for example. Multiple different sensors 103 built into computing device report to the controller 101, and form a management controller module or subsystem 113. For example, the sensors 103 can include sensors which are operable to provide values for measurements of device parameters such as temperature, cooling fan speeds, power status, and operating system (OS) status for example. Controller 101 monitors the sensors 103 and can provide data relating to the measured values for parameters via a network interface controller 105 connected to a network 107 for example.

The controller 101 is typically operatively coupled to certain other functional components of the device 100 such as memory 109 which can include volatile and non-volatile memory including magnetic and/or optical disc based storage devices for example, and a processor or processors 111 for the device 100.

According to an example, an agent module 115 for the device 100 runs at device start up to handle communication with controller 101. It can query or poll the controller 101 once every second and provide a measurement which has been retrieved for storage in memory 109. For example, a current power consumption value can be stored in memory 109 for use by other applications which may be executed or executing on the device 100, or which may be otherwise able to retrieve a measurement from memory 109 such as via the network 107. A power consumption of the device 100 when it is “idle”, i.e. with no applications or virtual machines running is a “baseline” or reference value. Deviation from this reference value can provide an indication of power consumption for an application or virtual machine which is executed on or for the device 100.

In an example, agent module 115 consists of two separate components, a daemon 117 and a shared library 119.

In an example, the daemon 117 can be executed with a suitable command, and a child process is forked and a lock file is produced. The daemon 117 then initiates connection with the subsystem 113 and requests a current power consumption value once every second, or at some other desired frequency. The value can then be stored memory 109, which can be a shared memory. The daemon 117 can be stopped with a suitable command to cause the shared memory and the lock file to be removed and to terminate the daemon.

In an example, a reference or baseline value can be set with a suitable command which can be forced to use a specific value if desired. If such a value is provided, it sets the baseline (power consumption on idle) value in shared memory to the supplied value. This option may be appropriate if an idle consumption value has been provided by the hardware vendor. If <value> is not provided, the agent module 115 reads the current power consumption reading and stores it as the baseline. This option may be appropriate where no known baseline exists, in which case the command could be issued during device start up.

A current power consumption value can be displayed if a suitable command is provided. For example, a command can cause access to the current value from memory 109 and output it to a standard output. In an example, such a command can use a shared library to read the value. The shared library can allow third-party applications to access the current power consumption reading and the baseline value (if set), and can consist of the library itself, a header file which contains function prototypes and a Java class for example.

While it has been possible for some time to directly measure the power consumption of a physical server, more and more organisations are turning to the use of virtual machines to host their applications and IT infrastructure. With the advent of Cloud technology, the servers hosting these virtual systems may be geographically remote from the organisation responsible and are often physically inaccessible. This introduces a new challenge—that of working out what proportion of a physical server's power is being consumed by an individual virtual machine.

Typically, it is difficult to measure exactly how much physical power is being consumed by a virtual system. However, it is possible to make an accurate estimate for most cases, based on the relative CPU usage of a virtual machine as a proportion of the overall CPU resource. In an example, the Agent module 115 uses the following formula to estimate the power consumption of a virtual machine:

a. mypower=(mycpupct/totalcpupct)*(totalpower−baseline)

where:
b. mycpupct=the virtual machines CPU use (as a percentage of physical server CPU capability)
c. totalcpupct=total CPU use of all machines, including the host OS, also as a percentage of the total physical server CPU capability.
d. totalpower=the current server power consumption, via Agent module 115
e. baseline=the baseline (idle) power consumption, via Agent module 115

A practical example of the use of the Agent module 115 to view the individual power consumption of virtual machines is by modifying the “xentop” tool supplied with Xen, so that it interfaces with the Agent module 115.

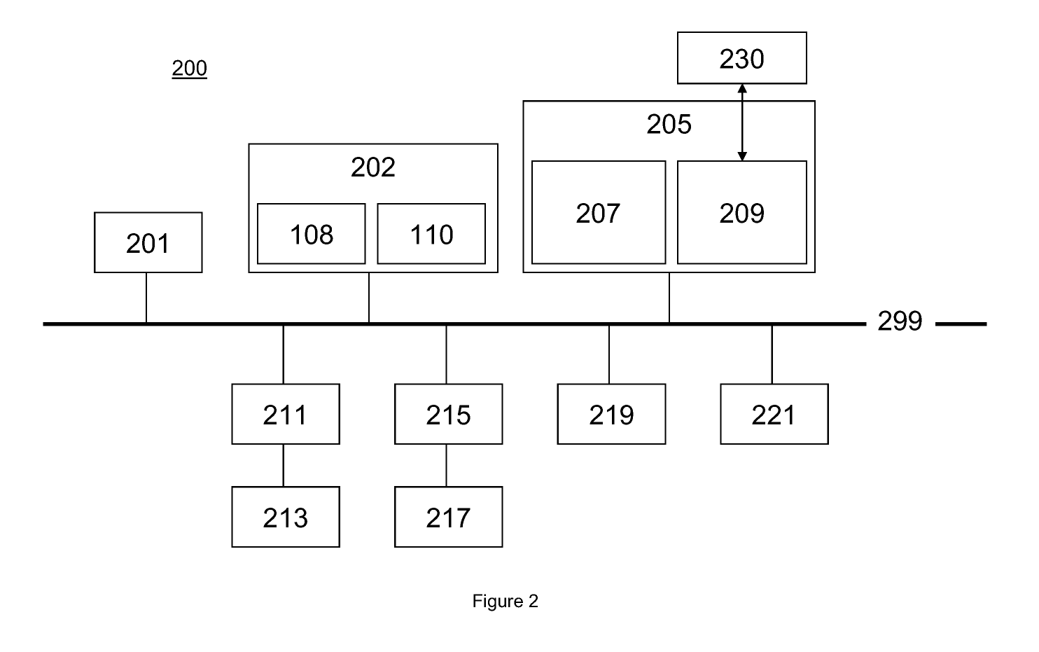

FIG. 2 is a schematic block diagram of a system according to an example, and which is suitable for implementing any of the systems, methods or processes described above, and which can be a computing device, a server or a platform suitable for hosting one or more virtual machines for example. Apparatus 200 includes one or more processors, such as processor 201, providing an execution platform for executing machine readable instructions such as software. Commands and data from the processor 201 are communicated over a communication bus 299. The system 200 also includes a main memory 202, such as a Random Access Memory (RAM), where machine readable instructions may reside during runtime, and a secondary memory 205. The secondary memory 205 includes, for example, a hard disk drive 207 and/or a removable storage drive 230, representing a floppy diskette drive, a magnetic tape drive, a compact disk drive, etc., or a nonvolatile memory where a copy of the machine readable instructions or software may be stored. The secondary memory 205 may also include ROM (read only memory), EPROM (erasable, programmable ROM), EEPROM (electrically erasable, programmable ROM). In addition to software, data representing any one or more of an agent module, power consumption estimate or value, reference or baseline value and so on for example may be stored in the main memory 202 and/or the secondary memory 205. The removable storage drive 230 reads from and/or writes to a removable storage unit 209 in a well-known manner.

A user can interface with the system 200 with one or more input devices 211, such as a keyboard, a mouse, a stylus, and the like in order to provide user input data for example. The display adaptor 215 interfaces with the communication bus 299 and the display 217 and receives display data from the processor 201 and converts the display data into display commands for the display 217. A network interface 219 is provided for communicating with other systems and devices via a network such as network 101 for example. The system can include a wireless interface 221 for communicating with wireless devices in the wireless community.

It will be apparent to one of ordinary skill in the art that one or more of the components of the system 200 may not be included and/or other components may be added as is known in the art. The system 200 shown in FIG. 2 is provided as an example of a possible platform that may be used, and other types of platforms may be used as is known in the art. One or more of the steps described above may be implemented as instructions embedded on a computer readable medium and executed on the system 200. The steps may be embodied by a computer program, which may exist in a variety of forms both active and inactive. For example, they may exist as software program(s) comprised of program instructions in source code, object code, executable code or other formats for performing some of the steps. Any of the above may be embodied on a computer readable medium, which include storage devices and signals, in compressed or uncompressed form. Examples of suitable computer readable storage devices include conventional computer system RAM (random access memory), ROM (read only memory), EPROM (erasable, programmable ROM), EEPROM (electrically erasable, programmable ROM), and magnetic or optical disks or tapes. Examples of computer readable signals, whether modulated using a carrier or not, are signals that a computer system hosting or running a computer program may be configured to access, including signals downloaded through the Internet or other networks. Concrete examples of the foregoing include distribution of the programs on a CD ROM or via Internet download. The same is true of computer networks in general. It is therefore to be understood that those functions enumerated above may be performed by any electronic device capable of executing the above-described functions.

According to an example, an agent module 115 can reside in memory 202 and operate on data from input sources. Further, an application 110 can reside in memory 202, which application can cause a change to the power consumption of the device when executing for example.

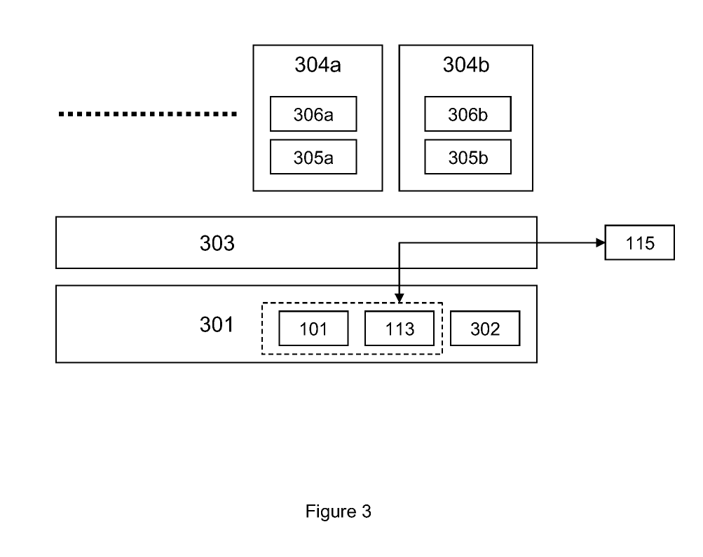

FIG. 3 is a schematic block diagram of a virtual machine according to an example. A physical machine 301 comprises computer hardware, such as a personal computer or a server, or any other appropriate type of computer or device such as that described above with reference to FIG. 2. Physical machine 301 executes an operating system (OS) 302; the OS may be any appropriate operating system, such as, for example, Microsoft Windows, Unix, or Linux. A virtual machine manager (VMM) 303 runs on physical machine 301 to coordinate execution of VMs 304a and 304b. While two VMs are shown in FIG. 3, any appropriate number of VMs may be supported by a single VMM. VMM 303 acts as an arbitrator between the multiple VM sessions, and allocates system resources of physical machine 301 to each VM session, including one or more of memory, address space, input/output bandwidth, and processor runtime. VMM 303 resides on physical machine 301. Each VM 304a-b runs an operating system 305a-b; each VM may run a different operating system, as desired by an administrator for example. Operating systems 305a-b support applications 306a-b; these applications may be any appropriate application software for remote use by the user for example.

A management controller 101 as part of a subsystem 113 resides on physical machine 301 and can therefore provide data representing certain operating parameters of the hardware 301 such as CPU load and so on. Similarly to that described with reference to FIG. 1, agent 115 can query controller subsystem 113 and hence controller 101. In an example, agent 115 can query subsystem 113 via OS 303. Alternatively, a query can be performed via a VM residing on machine 301. For example, a DomO VM can be used to query the controller.

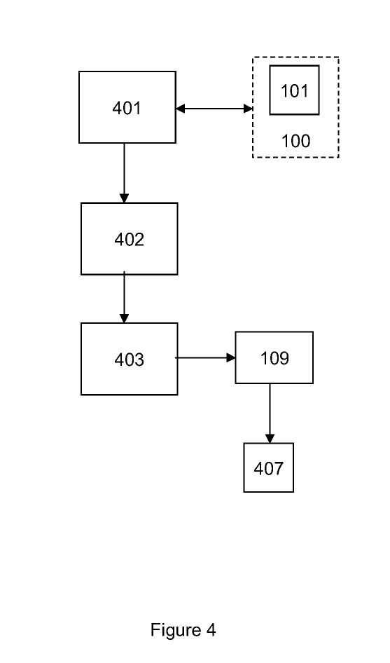

FIG. 4 is a flowchart for a method according to an example. In block 401 a management controller 101 of a device 100 is periodically polled or otherwise queried for a power consumption measurement 402 from a sensor which is communicatively coupled to the controller. In block 403 the measurement is stored in a memory 109 of the device 100 to make it available for use by an application 407.

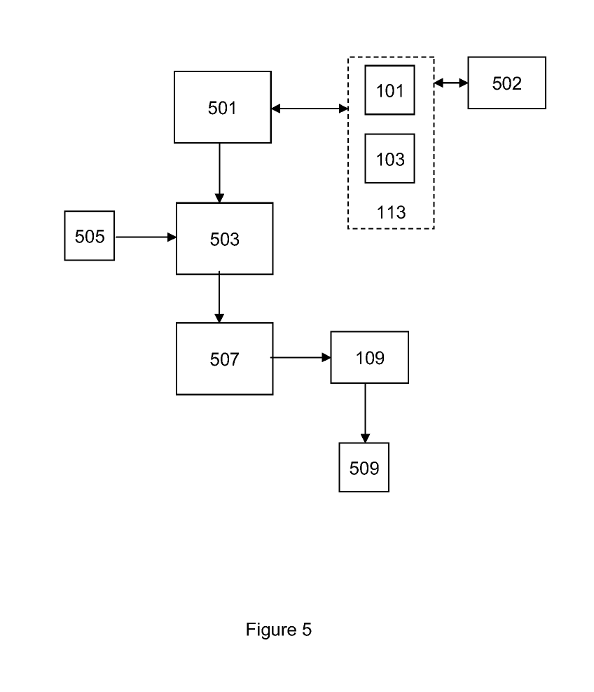

FIG. 5 is a flowchart for a method according to an example. In block 501 a management controller 101 of a host server 502 which can be in the form of a device such as that described with reference to FIG. 2 is periodically polled or otherwise queried for a power consumption measurement from a sensor 103 communicatively coupled to the controller 101 and representing a current server power consumption value. In block 503 the measurement is used to estimate the power consumption of a virtual machine 304a, 304b with reference to a reference value 505 for power consumption of the server and a number of hosted virtual machines on the server. In block 507 the value is stored in a memory 109 of the server to make it available for use by an application 509.

In one example, the basis for estimation of power consumption of a virtual machine is based upon estimation of CPU power usage only. Although other elements of the system, for example storage devices, network usage and the like, consume power, studies have shown that the CPU power usage is a reasonable measure of overall power usage. In other examples, the system and method make use of power usage estimates for these other components.

One particular use of power consumption monitoring is in the calculation of a server'/s so-called “carbon footprint”. The carbon dioxide generated by electricity power generation differs across the different power generation techniques. In an extension of the system and method described above, the power consumption data can be used to determine the amount of carbon dioxide being emitted by the electricity generation needed for the server concerned. This measure is known as the “carbon footprint”.

Combining the power consumption data with carbon emission data for a particular electricity supplier, it is possible to calculate the carbon footprint for a particular server, server cluster, datacentre or organisation. The carbon emission data can be stored locally, or could be retrieved in real time when the calculations are required. The resulting carbon footprint information can be used in a static manner, as a record, or in a proactive manner in order to manage electricity suppliers in order to reduce the carbon footprint of the elements being monitored.

In addition, where a datacentre is used to host multiple virtual servers on a single physical server, the techniques described above are able to produce a carbon footprint calculation for those virtual servers, thereby enabling sophisticated apportionment of carbon footprint between the organisations using the virtual servers.

What is claimed is:

1. A method implemented on a computing device for monitoring power consumption of an activity executing on the device, the method comprising:
periodically polling a management controller of the device for a power consumption measurement from a sensor communicatively coupled to the controller; and
storing the measurement in a memory of the device to make it available for use by an application.

2. A method as claimed in claim 1, wherein polling a management controller includes making an out-of-band request for power consumption data from the controller.

3. A method as claimed in claim 1, wherein the management controller is polled at least once every second.

4. A method as claimed in claim 1, wherein the stored measurement is used to provide a reference value for the power consumption.

5. A method as claimed in claim 4, wherein the reference value represents an operating state of the device when under no application or virtual machine load.

6. A method implemented on a computing device for monitoring power consumption of a virtual machine residing on a physical host server, the method comprising:
periodically polling a management controller of the host server for a power consumption measurement from a sensor communicatively coupled to the controller and representing a current server power consumption value;
using the measurement to estimate the power consumption of the virtual machine with reference to a reference value for power consumption of the server and a number of hosted virtual machines on the server, thereby producing power consumption values; and
storing the power consumption values in a memory of the server to make it available for use by an application.

7. A method as claimed in claim 6, wherein determining the power consumption of the virtual machine includes determining the relative CPU usage of the virtual machine as a proportion of the overall CPU resource of all virtual machines including a host OS residing on the server.

8. A method as claimed in claim 6, wherein the management controller is polled at least once every second.

9. A method as claimed in claim 6, wherein the stored measurement is used to provide the reference value for the power consumption.

10. A method as claimed in claim 9, wherein the reference value represents an operating state of the server when under no application or virtual machine load.

11. A system for determining power consumption of an activity executing on a device, comprising:
a management controller of the device to determine a power consumption value from a sensor communicatively coupled to the controller;
an agent module to periodically poll the management controller for the power consumption value; and
a memory to store the power consumption value to make it available for use by an application.

12. A system as claimed in claim 11, wherein the agent is operable to poll the management controller at least once every second.

13. A system as claimed in claim 11, wherein the management controller is operable to provide a reference value representing an operating state of the device when under no application or virtual machine load.

14. A system as claimed in claim 11, wherein the device is a host server operable to execute a virtual machine manager to support a virtual machine.

15. A system as claimed in claim 14, further comprising a processor operable to determine the power consumption of the virtual machine with reference to a reference value for power consumption of the server and a number of hosted virtual machines on the server.

16. A system as claimed in claim 15, wherein the processor is operable to determine the power consumption of the virtual machine by computing the relative CPU usage of the virtual machine as a proportion of the overall CPU resource of all virtual machines including a host OS residing on the server.
